(19) United States
(12) Patent Application Publication
(10) Pub. No.: US 2010/0236580 A1
(43) Pub. Date: Sep. 23, 2010

(54) METHOD AND SYSTEM FOR REMOVING PCBs FROM SYNTHETIC RESIN MATERIALS

(76) Inventor: Gary M. Delaurentiis, Jamestown, CA (US)

Correspondence Address: Roeder & Broder LLP, 5560 Chelsea Avenue, La Jolla, CA, 92037, US

(21) Appl. No.: 12/599,974

(22) PCT Filed: May 13, 2008
(86) PCT No.: PCT/US08/06100

§ 371 Date: Nov. 12, 2009

Related U.S. Application Data
(60) Provisional application No. 60/930,375, filed on May 15, 2007.

(51) Int. Cl. B08B 3/00

(52) U.S. Cl. 134/26; 134/95.1

(57) ABSTRACT

A system that removes PCBs from synthetic resins in an environmentally safe and economical manner. The system includes a solvent wash subsystem (10) including a first tank (44) to expose the resin particles to a solvent for a first predetermined period of time. In the solvent tank (44), the solvent contacts the resin particles, removing the PCBs. Thereafter, a separator is provided to separate the solvent from the resin particles after removal from the first tank (44). The system also includes a carbon dioxide subsystem (34) where, after separation, the resin particles are exposed to carbon dioxide in a vessel for a second predetermined period of time. Exposure to the carbon dioxide substantially removes any residual solvent and trace amounts of PCBs remaining on the resin particles. In various embodiments, the first predetermined period of time and the second predetermined period of time are selected so that the PCBs on the resin particles are reduced to a predetermined acceptable level, for example, 2.8 million parts per million or less. Exposure to the solvent and the carbon dioxide can be either performed (i) in one continuous cycle for the first period of time and the second period of time respectively; or (ii) in a number of successive cycles, where the sum of the exposure times of the cycles equals the first and second periods of time respectively.

### BACKGROUND OF THE INVENTION

1. Field of the Invention

The present invention relates to a method and system for removing PCBs from synthetic resin materials, such as plastic. More particularly, the present invention relates to a method and system for removing PCBs from synthetic resin materials using a solvent wash and carbon dioxide (CO2).

2. Description of the Prior Art

Polychlorinated biphenyls, commonly known as PCBs, are chlorinated compounds. PCBs are either oily liquids or solids that are colorless to light yellow. In the past, PCBs have been widely used in industry. Common products that used PCBs included fluorescent lighting fixtures, electrical appliances such as televisions and refrigerators, electronic capacitors, hydraulic oils, etc. The manufacture of PCBs was stopped in the U.S. in the late 1970s. It was found that PCBs compounds were a health hazard and harmful to the environment. Studies have demonstrated that PCBs are carcinogens that have been linked to certain types of cancers in humans.

Even though they have been banned in the U.S. for some time now, PCBs are still entering the environment and contaminating the air, water, and soil. PCBs are being released into the environment from hazardous waste sites, illegal or improper disposal of industrial wastes and consumer products, leaks from old electrical transformers containing PCBs and the burning of some wastes in incinerators. PCBs do not readily break down in the environment and thus may remain there for very long periods of time.

According to estimates from the automotive industry, more than 90% of all motor vehicles, automobiles, trucks, buses, etc., are removed from service are processed for recycling. This equates to more than 10 million vehicles each year just in the U.S. alone. Auto Shredder Residue (ASR) or “fluff” is the non-metallic waste product that results from the reclamation process. The ASR generally consists of a combination of plastics, rubber, glass, wood products, cloth, paper, foam, dirt, and electrical wiring. In addition, common household appliances such as washers, dryers and refrigerators are also reclaimed each year. The non-metallic waste from appliances, such as plastics, rubber, electronic components, wires, etc., is another substantial source of fluff. It is estimated that billions of pounds of fluff is generated annually, the majority of which is currently landfilled. For the sake of simplicity, the non-metallic waste from either vehicles or appliances will hereafter be generically referred to as “fluff”.

PCBs were commonly used in electronic components such as capacitors, transformers, etc. Since these electrical components are commonly used in automobiles and appliances, PCBs may be released into the fluff during the reclaiming of vehicles and appliances. Fluff contaminated with PCBs is problematic for several reasons. If the level of PCB contamination is too high, the fluff may be considered a hazardous material under the guidelines of the U.S. Environmental Protection Agency (EPA). In which case, the fluff may have to be disposed as a hazardous waste, which is significantly more expensive than landfilling the material. Also with certain types of fluff, such as plastics and synthetic resins, the material cannot be recycled if the PCB contamination level is too high. Current EPA regulations require PCB contamination be less than 2.0 parts per million. Unless the PCB levels can be reduced to at or below this level, the plastics and synthetic resins recovered from fluff cannot be recycled and is typically landfilled.

Currently there is no known commercially viable process to remove PCBs from plastics and synthetic resins recovered from fluff. A system and method that will produce essentially PCB-free synthetic resin materials from fluff, such as plastic and synthetic resins, in an environmentally safe and economical manner, is therefore needed.

### SUMMARY OF THE INVENTION

A method and system that removes PCBs from synthetic resins in an environmentally safe and economical manner is disclosed. The system includes a solvent Wash subsystem, including at least one tank, to expose the resin particles to a solvent for a first predetermined period of time. When the solvent contacts the resin particles, the PCBs are removed from the resin. Thereafter, a separator is provided to separate the solvent from the resin particles after removal from the solvent. The system also includes a carbon dioxide subsystem where, after separation, the resin particles are exposed to carbon dioxide in a vessel for a second predetermined period of time. Exposure to the carbon dioxide substantially removes any residual solvent and trace amounts of PCBs remaining on the resin particles. In various embodiments, the carbon dioxide in the vessel can be either in a liquid or supercritical state. In the method of the present invention, the resin particles can be passed through a predetermined number of solvent wash, separation, and carbon dioxide exposure cycles. In yet other embodiments, the duration of the first predetermined period of time and the second predetermined period of time, as well as the number of solvent wash-separation and carbon dioxide exposure cycles, can be selectively varied so that the PCBs on the resin particles are reduced to a predetermined acceptable level, for example, 2.0 parts per million or less.

### BRIEF DESCRIPTION OF THE DRAWING FIGURES

Various embodiments of the present invention is described in detail below with reference to the attached drawing figures, wherein:

FIG. 1 is a schematic diagram depicting a three-stage solvent system and a liquid or supercritical carbon dioxide system for removing PCBs from particulate synthetic resin material according to one embodiment of the present invention.

FIG. 2 is a detailed view of the three-stage solvent system shown in FIG. 1 according to the present invention.

FIGS. 3A-3C is a series of diagrams illustrating a resin recycling system for removing PCBs according to another embodiment of the present invention.

Like reference numbers in the figures refer to like elements.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

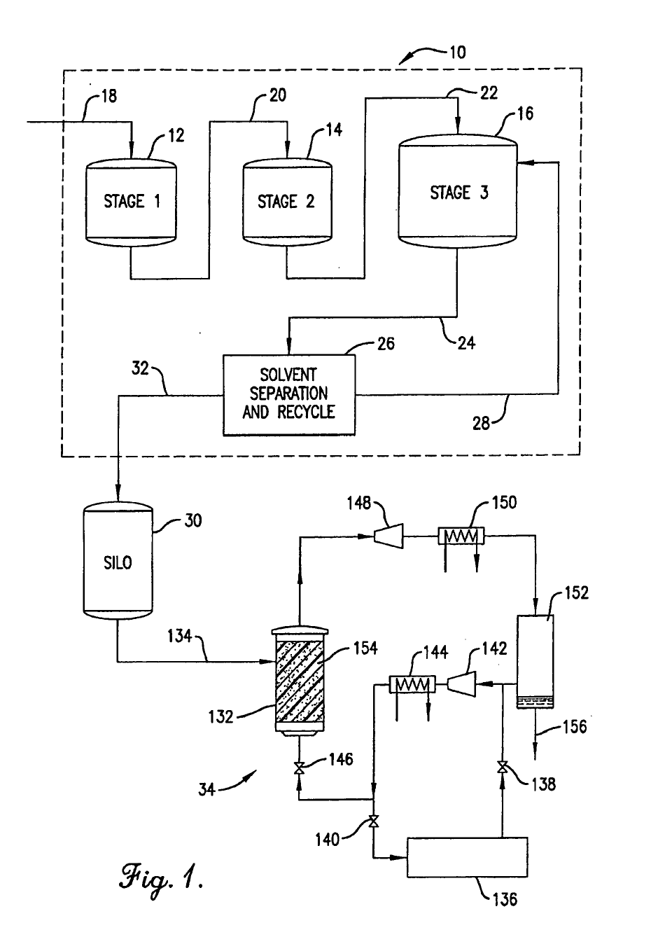

FIG. 1 is a block diagram of one embodiment of a system for removing PCBs from synthetic resins and plastics, hereafter generically referred to as “resin”, recovered from fluff, in a safe and environmentally friendly manner. The system includes a liquid solvent cleaning sub-system 10. Solvent cleaning sub-system 10 includes, in the particular embodiment shown, three separate cleaning stages 12, 14, and 16. Particulate synthetic resin material, illustrated as feed stream 18, is initially loaded into the first stage 12, which contains a liquid solvent. In the first stage 12, the particulate resin is vigorously mixed with the solvent. Thereafter, the particulate resin, illustrated as stream 20, is transferred to a second stage 14. Stage 14 operates in a very similar manner to stage 12 in that the particulate resin is mixed with additional quantities of solvent. After the second stage 14, the particulate resin, illustrated as stream 22, is transferred to a third stage 16. Again, the third stage 16 is similar in operation to the first two stages 12, 14. In one embodiment, the solvent purity increases from stage 12 to stage 14 to stage 16. The solvent contained in each successive stage is cleaner than the previous stage in order to achieve the maximum solvation of the PCBs present on the synthetic resin material. It should be noted that the three stages illustrated in FIG. 1 is merely exemplary. In other embodiments, as discussed below, either fewer or more solvent wash stages may be used in subsystem 10.

After the solvent wash, regardless of the number of stages used, the particulate resin, illustrated as stream 24, is then sent to a solvent separation and recycling station 26. At station 26, a substantial portion of the solvent is separated from the particulate resin. In one embodiment, station 26 employs a device, such as a spin dryer, to mechanically separate the solvent from the particulate resin. The particulate material is then sent to a silo 30 via stream 32 to wait further processing. In yet other embodiments, the PCBs and other contaminants may be removed from the solvent at station 26, using for example either a distillation process or filtration, so the solvent can be returned to substation 10 through feed line 28 for reuse.

The downstream portion of the process comprises a carbon dioxide cleaning subsystem 34. The subsystem 34 is nearly the same as that disclosed in U.S. Pat. No. 5,711,820, which is incorporated by reference herein. The objective of carbon dioxide system 34 in the context of the present invention, however, is different than in the '820 patent. In the '820 patent, the objective of the carbon dioxide system is the removal of oil from the resin. In contrast, the main purpose of the solvent wash in the present invention is the removal of PCBs from plastic and synthetic resins, such as those reclaimed from auto and appliance fluff. The carbon dioxide subsystem 34 is mainly used to remove any residual solvent and PCBs remaining after the solvent wash and separation. In one embodiment, the solvent used in solvent cleaning system 10 is relatively soluble in liquid or supercritical carbon dioxide. As a result, the carbon dioxide subsystem 34 can operate at lower pressures and/or temperatures than if the carbon dioxide system 34 alone was directly solvating or removing the PCBs from the resin. Maintaining the carbon dioxide system 34 at lower pressures and/or temperatures generally lowers equipment and the cost of operation.

In one embodiment, subsystem 10 is a closed system employing vessels that are sealed or blanketed with an inert gas such as nitrogen to prevent volatilization and the escape of solvent to the outside environment. In addition, silo 30 is a closed vessel and does not permit much if any residual solvent adhered to the synthetic resin particles to escape to the environment. As a closed system, system 10 does not present significant environmental concerns as it is relatively self-contained and does not produce significant emissions. Also, the closed nature of system 10 allows for recycling of a substantial portion of the liquid solvent used therein. These features result in a reduction in operating costs and also avoids having to deal with the clean up of PCBs or other contaminants.

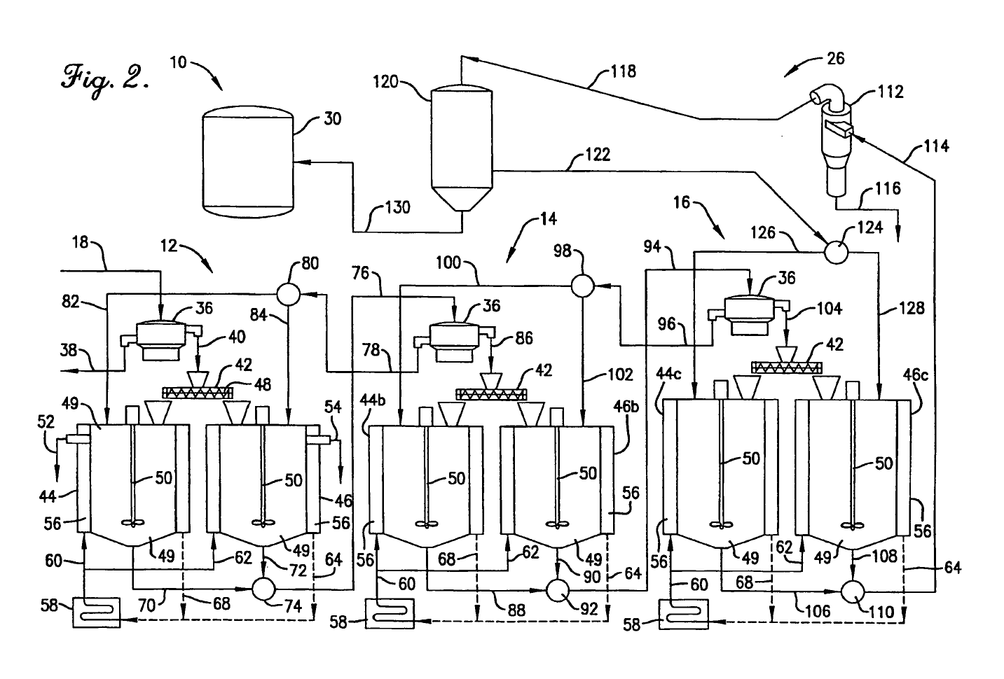

Turning now to FIG. 2, the solvent cleaning subsystem 10 is shown in greater detail. Stages 12, 14 and 16 are relatively similar with the possible exception of equipment sizing. Therefore, those features common to all three stages are described using the same reference numerals. A feed stream 18 of particulate material (i.e., plastic and synthetic resin) ground into approximately ⅜″ particles enters stage 12 and is directed initially to a separator 36 primarily for separation of unacceptably large particles that could be difficult to process. The separator 36 can be any sieve or filter-type apparatus suitable for performing this separation. In one embodiment, a Sweco separator is used. The rejected particles exit separator 36 through stream 38 and may be returned to a shredding or grinding device (not shown) for further processing to reach an acceptable size (approximately ⅜″). It should be noted the size defined above is only exemplary. Particles either larger or smaller than ⅜″ can be used.

Synthetic resin particles of acceptable size exit separator 36 through stream 40 and are directed toward a conveyer 42 for distribution to either of cleaning tanks 44 or 46. Conveyer 42 comprises a reversible auger 48 that is capable of directing the particulate material to both tanks 44 and 46. In operation, the material is loaded into one tank until its capacity has been reached. The cleaning cycle is begun in that tank and auger 48 reverses direction so as to begin filling the other tank. By providing two tanks in parallel, a nearly continuous process may be achieved.

In one embodiment, the tanks 44 and 46 are double-walled tanks. The inner compartments 49 contain the liquid solvent capable of solvating or removing PCBs that may be present on the synthetic resin material. This double-wall feature provides extra protection against accidental release of solvent, PCBs or other contaminants.

Each of tanks 44 and 46 is equipped with a mixer 50 for agitating the contents of the tank. In various embodiments, this agitation is significant and can be characterized as violent so as to insure the maximum possible contact of the synthetic resin material with the solvent. One example of a mixer 50 for use with the present system is a Neptune mixer having at least one propeller attached to the mixer shaft.

As previously stated, tanks 44 and 46 are jacketed. The outer compartment 56 of each tank contains a heat transfer fluid for heating and maintaining the temperature of the solvent within the inner compartments 49. Preferably, any suitable heat transfer fluid may be used, however, a glycol such as propylene glycol or ethylene glycol is used in one embodiment. The heat transfer fluid is heated to a temperature of between about 170-190° F. using heat exchanger 58. Consequently, the solvent contained within the inner compartment 49 will also be heated to a temperature between about 170-190° F. Using a jacketed vessel and a heat exchanger allows heating to be accomplished without the use of an open flame near the solvent vessel. This feature adds to the overall safety of the system. The glycol solution is constantly circulated between tanks 44 and 46 and heat exchanger 58 via conduits 60, 62, 64, and 68.

In alternative embodiments, the solvent is not heated to such a high temperature. In various embodiments, the solvent is heated in the range of 90 to 170° F. In various embodiments, the solvent is heated to approximately 100° F., 110° F., 120° F., 130° F., 140° F., 150° F., 160° F. or 170° F., give or take 5° F. or 10° F. In one specific embodiment, the solvent is heated to 125° F. The lower temperatures help reduce operating costs and reduce the amount of solvent loss due to evaporation. In these alternative embodiments, the temperature of the heat transfer fluid is controlled to achieve the desired to temperature of the solvent.

The synthetic resin particles and solvent are agitated in the tanks 44 and 46 for a predetermined length of time. This length of time is dependant upon many factors such as tank size; solvent purity, and the nature of the solvent itself and its capacity for solubilizing the PCBs. In various embodiments, the time period includes more than 15 minutes, less than 15 minutes, between 10-15 minutes, between 1-12 minutes, between 5-10 minutes, or between 3-5 minutes, for example approximately 4 minutes. At the end of the agitation cycle, the contents of either tank 44 or 46 are emptied via conduit 70 or 72, respectively. The slurry comprising solvent and synthetic resin material is then pumped by pump 74 and directed to stage 14 via conduit 76.

At stage 14, the slurry passes through a second separator 36 whereby the particulate material is separated from the solvent, which is then recycled back to stage 12 via conduit 78. Pump 80 directs the recycled solvent to either tank 44 or 46 via conduits 82 or 84, respectively. The synthetic resin material, illustrated as stream 86, is directed to a second conveyer 42, which distributes the particulate material between tanks 44b and 46b. Stage 14 then operates in a similar manner to stage 12. At the completion of the agitation cycle, the slurry of solvent and particulate material exits the respective tank through conduit 88 or 90 and is pumped by pump 92 to stage 16 via conduit 94.

Stage 16 begins with the slurry being passed through a third separator 36 with the solvent being separated and recycled back to stage 14 through conduit 96. Pump 98 directs the recycled solvent back to the appropriate tank 44a and 44b through either conduit 100 or 102. The synthetic resin material leaves separator 36 as stream 104 and is directed to conveyer 42 for distribution between tanks 44c and 46c. Stage 16 then operates in a manner that is similar to the operation of stages 12 and 14. At the completion of the agitation cycle, the solvent and synthetic resin material slurry exits tanks 44c and 46c via conduits 106 and 108, respectively, and is pumped by pump 110 to hydro cyclone 112 via conduit 114.

The hydro cyclone 112 separates solid waste material present in the slurry from the particulate synthetic resin material. The solid waste could be any undesirable particulate material present in the slurry including metal particles and other solid particles that heretofore may have not been separated from the synthetic resin material or solvent. This waste then exits the system as stream 116. The ratio of solvent to synthetic resin material present in the slurry entering the hydro cyclone is dependent upon a number of factors such as the density of the synthetic resin material. Furthermore, the interior of the hydro cyclone may have to be changed depending upon the different types of synthetic resin material present in the slurry.

The slurry is directed through conduit 118 toward spin dryer 120 where a substantial portion of the solvent is separated from the synthetic resin material and recycled back to stage 16 through conduit 122 and pump 124. The recycled solvent is then distributed between tanks 44c and 46c through conduits 126 and 128. Spin dryer 120 in one embodiment removes at least about 90% by weight of the solvent present in the slurry, more preferably at least about 95% by weight of the solvent, and most preferably at least about 98% by weight of the solvent. In alternative embodiments, less than 90% by weight of the solvent present in the slurry may be removed. After exiting the spin dryer, the particulate synthetic resin material is transported as stream 130 to storage silo 30 where it is held until it can be sent to carbon dioxide subsystem 34.

The solvent used in subsystem 10 is carefully selected based on various desirable characteristics. First, the solvent should be capable of solvating PCBs and other contaminants without causing significant break down of the synthetic resin materials dispersed therein. Second, the solvent should exhibit a specific gravity to facilitate flotation separation of synthetic resin materials of different densities if desired, as described in detail below. If flotation separation is not desired for a particular implementation of the present invention, then the specific gravity of the solvent is not as critical a factor.

Suitable solvents may be selected from various classes of chemicals such as esters, ketones, glycols, glycol ethers, halogenated solvents, aromatics, alcohols, aliphatic hydrocarbons, amines, and terpenes. More specifically, the solvent is selected from the group consisting of amyl propionate, butyl butyrate, alkyl lactates, ethyl hexyl acetate, dibasic esters, methyl soyate, ethyl soyate, cyclohexanone, methyl ethyl ketone, dipropylene glycol, dipropylene glycol methyl ether, trichloroethylene, xylene, ethanol, tetrahydrofurfuryl alcohol, hexane, mineral spirits, monoethanolamine, d-limonene, dimethyl formamide, n-methyl pyrrolidone, propylene carbonate, and combinations thereof. Preferably, the solvent is an alkyl ester solvent having the general formula RCOOR′, wherein R and R′ are independently selected from C1-C10 alkyl groups and R contains at least one hydroxyl group. Alkyl lactates are particularly preferred solvents for use with the present invention.

In various embodiments, the alkyl lactates include methyl lactate, ethyl lactate, isopropyl lactate, and butyl lactate, all of which are available under the name PURASOLV by PURAC America, Inc., Lincolnshire, Ill. In one specific embodiment, a particular alkyl lactate, ethyl lactate is used. These solvents exhibit specific gravities at 20° C. of between 0.98-1.09, are generally miscible with water, and have a high capacity for solvating various organic contaminants such as grease and oil as well as PCBs. Furthermore, these solvents are relatively non-toxic and, in some instances, have been approved by the FDA for food applications. The lack of solvent toxicity is an added benefit and contributes to the environmentally friendly nature of this system.

Solvent compatibility with the synthetic resin material is also an important property as it is undesirable for the solvent to solvate the synthetic resin material in addition to the PCBs or other contaminants. Synthetic resin material such as polypropylene, polyethylene, polyethylene terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), and combinations thereof, are considered to be compatible with many of the solvents listed above according to the present invention.

Carbon dioxide subsystem 34, as shown in FIG. 1, is an exemplary closed loop separation subsystem suitable for separation of residual solvent adhered to the synthetic resin particles after treatment in solvent subsystem 10. Carbon dioxide subsystem 34 is also capable of removing PCBs and other contaminants that may still be present on the synthetic resin particles; however, the primary function of subsystem 34 is to separate the solvent residue from the particles since the majority of the PCBs have already been removed by the solvent. To the extent any PCBs remain on the resin, the carbon dioxide subsystem 34 will act to remove these contaminants as well.

The particulate synthetic resin material is transferred from storage silo 30 to extraction vessel 132 via stream 134 (preferably an auger transport device). Typically, the material will be enclosed in a steel mesh basket or other porous metal enclosure so that the synthetic resin material will not be swept out of the extraction vessel 132 into other portions of the separation system 34 by the flowing carbon dioxide described below. The system is then filled with carbon dioxide from a reservoir 136 through a control valve 138 to a pressure suitable to satisfy the desired pressure and temperature conditions in operation as described further below. With the control valves 138 and 140 shut off, carbon dioxide flow is established from the compressor 142 and associated heat exchanger 144 through control valve 146, through the extraction vessel 132, through the expansion device 148 and associated heat exchanger 150, through separation vessel 152 and to the compressor 142 for another cycle. Adjustments to the compressor 142 speed, expansion device 148, and the temperature of the heat exchangers 144 and 150 allows the extraction vessel 132 and separation vessel 152 to be maintained at the desired pressures and temperatures as described further below. Such adjustments may be made manually or controlled by commercially-available computer software and equipment. The overall charge of the system may be adjusted by admitting more carbon dioxide from reservoir 136 through control valve 138 or by discharging carbon dioxide to the reservoir through control valve 140.

In the extraction vessel 132, the desired temperature and pressure for solvency of the solvent in liquid or supercritical carbon dioxide is typically, according to various embodiments, ranges from about 600-1150, 650-1000, or 700-800, less than 600, or more than 1150 psia. The temperature may range, according to other embodiments, from about 20-100° C., about 30-90° C., 90 to 110° C., from about 60-70° C., less than or greater than 110° C. The resin particles are exposed to the carbon dioxide in the carbon dioxide vessel for one, according to various embodiments, of the following predetermined periods of time: six minutes or less; ten minutes or less; twelve minutes or less; fifteen minutes or less; twenty minutes or less; or thirty minutes or less. The solvent-free liquid or supercritical carbon dioxide continuously enters the bottom of the extraction vessel 132 and flows upward past the synthetic resin material 154, dissolving the solvent and/or PCBs carried on the material 154 (from subsystem 10) and flushing it away. In one embodiment, the flow of carbon dioxide is introduced to the bottom of extraction vessel 132, since the upward flow will tend to fluidize the bed of synthetic resin material 154 and hasten dissolution of the solvent.

The solvent-laden carbon dioxide continuously exits from the top of extraction vessel 132 and flows to the expansion device 148 and heat exchanger 150. Expansion device 148 and heat exchanger 150 are set such that the carbon dioxide entering the separator vessel 152 is in the gaseous phase; for example from about 400-1000 psia and from about 20-35° C. Under these gaseous conditions, the carbon dioxide has negligible solubility for the solvent, and therefore the solvent, including any trace amounts of PCBs or other contaminants, is precipitated out of solution, forming a two-phase system of liquid solvent and gaseous carbon dioxide, and the solvent collects in the bottom of separator vessel 152. The now solvent-free carbon dioxide gas is compressed through the compressor 142 wherein the pressure is raised equal to or greater than that of the extraction vessel 132. The temperature of the carbon dioxide then is adjusted to the desired value as it flows through heat exchanger 144, from where it reenters the extraction vessel 132 as either liquid or supercritical carbon dioxide to again dissolve and flush away solvent from the synthetic resin material 154. This recirculation of the carbon dioxide is continued until all of the solvent has been removed from the synthetic resin material and deposited in the separator vessel 152.

When the separation of the solvent from the synthetic resin material is complete, with control valve 146 closed, the clean carbon dioxide is routed into storage reservoir 136 through control valve 140 to be used again later. The solvent and PCB-free synthetic resin material 154 is removed from the extraction vessel 132, by for example a vacuum system, and sent to a storage silo. The solvent 156 recovered is drained from the separator vessel 152. The only waste released by this process is the small amount of carbon dioxide gas vented during final depressurization of the extraction vessel 132.

Periodically, the solvent used in stages 12, 14, and 16, as well as the solvent 156 recovered by carbon dioxide system 34, needs to be removed and purified as the solvent becomes saturated with PCBs and other contaminants. The time period for the removal is dependent upon a number of factors including the stage in which the solvent is being used and the solvent's capacity or solvating power (sometime referred to as the Kauri butanol value), but is typically every several hours. The solvent is drained from the respective stage or storage silo and sent to a distillation system for separation of the solvent and the contaminants. The operating conditions of the distillation system depend largely upon the flash point of the solvent, but preferred solvents according to the present invention are typically heated to about 300° F. and then re-condensed. The PCB and other contaminant waste are separated during this process and then properly disposed. Recovery of PCB and other contaminant waste for proper disposal is an important advantage of the present invention. If the PCB and other contaminants were not recovered, they would likely wind up in a landfill along with the synthetic resin material, where they could cause soil and groundwater contamination and other harms to people, animals and the environment. In an alternative embodiment, a filtration system may be used to remove the PCBs and other contaminants from the solvent.

The solvent stages 12, 14, and 16 need not be taken off-line for substantial periods of time during this process as fresh solvent can be added immediately following removal of the “dirty solvent” and the process continued while the dirty solvent is being purified. Subsystem 10 as shown in FIG. 2 is particularly designed to avoid this downtime as tanks 44 and 46 are situated in parallel, so that one tank is operational while the other is taken down for solvent change over. In essence, the subsystem 10 is designed to function as a continuous-batch process.

It should be noted that the number of tanks in the solvent wash system and the number of carbon dioxide systems 34 is arbitrary and is selected based on the desired throughput of the system. The specific number of stages 12, 14, and 16, tanks 44 and 46 and carbon dioxide subsystems 34 illustrated and described herein are exemplary and should in no way be construed as limiting the invention. Either more or fewer solvent wash tanks and carbon dioxide systems may be used.

The above-described process has been found to remove PCBs from plastic and synthetic resins. As noted above, federal guidelines require less than 2.0 parts per million as an acceptable level of contamination. The applicant has found that variations to the above process can be performed to bring PCB contamination levels significantly below those required by the federal government, and in some embodiments, down to virtually zero.

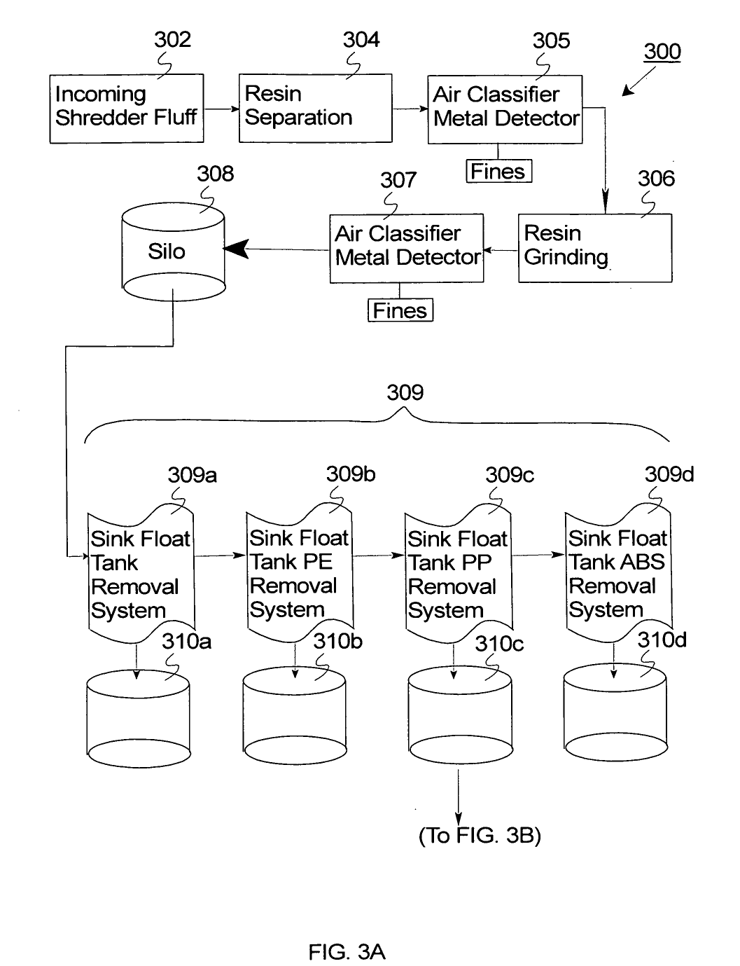

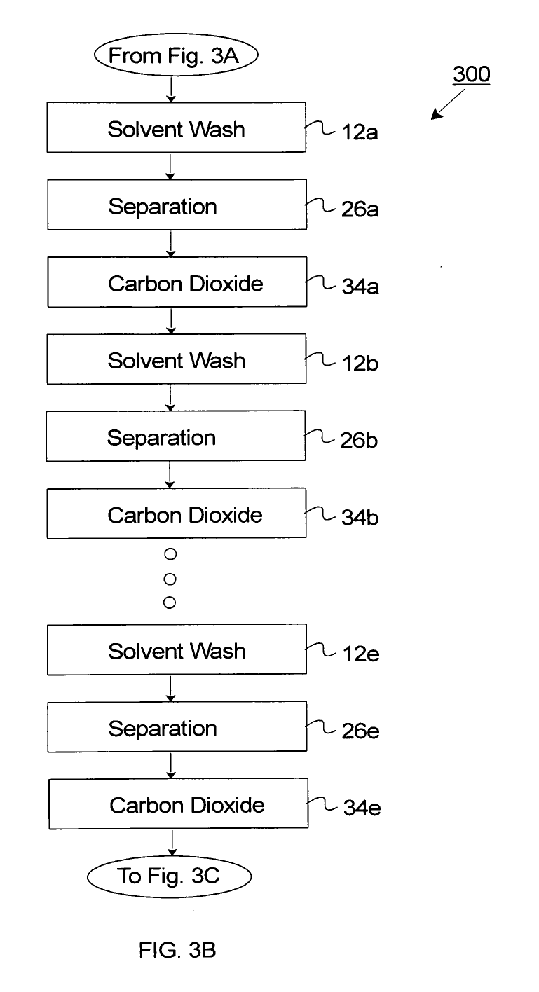

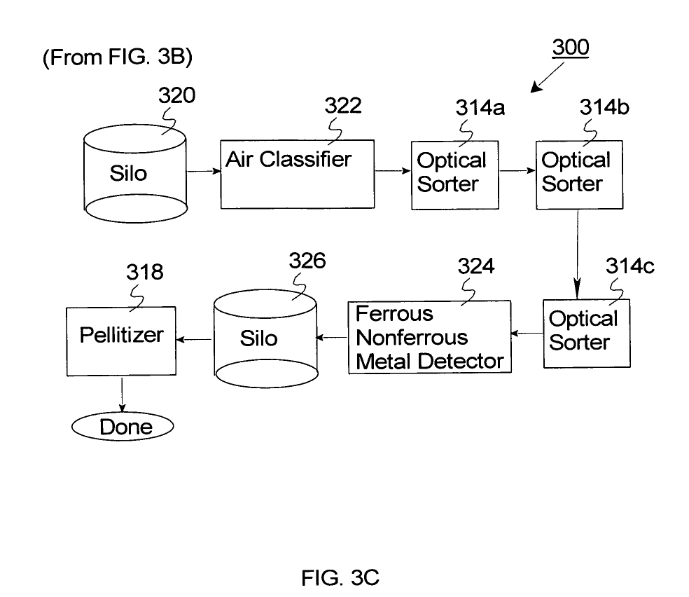

Referring to FIGS. 3A-3C, a sequence of diagrams illustrating an exemplary process flow of a system for removing PCBs from synthetic resins and plastics (hereafter generically referred to as “resin”) recovered from fluff, in a safe and environmentally friendly manner, in accordance with one embodiment, is shown.

The system 300 as illustrated in FIG. 3A includes an incoming fluff receiving stage 302, a resin separation stage 304, a first air classifier and metal detection stage 305, a grinding stage 306, a second air classifier and metal detection stage 307, a storage silo 308, and sink float sorting stage 309 including sink float tanks 309a-309d and storage silos 310a-310d for separating and storing different types of resins respectively.

The fluff generated from the reclamation of vehicles, appliances and other consumer items that are recycled is received at stage 302. The fluff generally includes a combination of plastics, rubber, glass, wood products, cloth, paper, foam, dirt, and electrical wiring. In one embodiment, the system 300 is provided in the same reclamation facility where the fluff is generated. In an alternative embodiment, the system 300 is provided in a separate facility and the fluff is transported from the reclamation facility to the location of the system 300.

If the fluff has not been presorted, resin separation is performed at stage 304. Typically the resin is sorted from rubber, glass, wood products, cloth, paper foam, etc, contained in the fluff. This process may be performed either manually, by a trommel, by sorting machines, or a combination thereof. As a general rule, the following types of synthetic resins are typically sorted out from auto and/or appliance fluff: Polypropylene (PP), acrylonitrile-butadiene-styrene (ABS), polyethylene (PE), and polycarbonate. For the remainder of this explanation, these types of synthetic resins will be generically referred to as resin, plastic, or both.

The grinding stage 306 includes a grinder used to grind the resin into small particles. In one embodiment, ⅜-inch resin particles are generated by the grinder. It should be noted that ⅜ inch sized particle has been found to be suitable for the down stream solvent wash and carbon dioxide stages 34. However it should be noted that this size should not be construed as limiting and that either larger or smaller sized particle may be used within the scope of the present invention.

The float sorting stage 309 includes sink-float separation tanks 309a-309d for separation of less dense synthetic resin material from more dense material. In silo 308, the different types of resins have not been sorted, and various plastics of different densities are all mixed together. The float sorting stage 309 accomplishes the separation by density through the use of solvents with different specific gravities in each tank 308a 308d respectively. For example, the tanks 308a, 308b, and 308c may be filled with solvents of different specific gravities so that PE, PP and ABS float to the top of the three tanks respectively. Within each tank 309, a skimming device may be used to remove the lesser dense material. Alternatively, gates located proximate the top of the tanks may be opened, thereby draining the lesser dense material, along with a quantity of solvent, may be used to achieve separation. Once the resin is separated by density (i.e., type), it may be stored in silos 310a-310d, each containing a different type of resin respectively.

Referring now to FIG. 3B, the resin stored in each silo 310 separately undergoes a sequence of solvent wash, separation and carbon dioxide cleanings in stages 12a, 26a and 34a through 12e, 26e and 34e respectively. Each stage 12, 26 and 34 is similar to that described above in relation to FIGS. 1 and 2, and therefore, is not described in detail herein. It should be noted, however, that the specific number of five solvent wash-separation-carbon dioxide wash cycles as shown should not be construed as limiting the present invention. Either fewer or more cycles may be used, depending on the amount of PCB contamination levels on the resin to begin with, the acceptable level of PCBs that may be tolerated after removal, and/or the desired throughput of the system. In alternative embodiments, any of the solvents listed above may be used. Also, the carbon used in subsystem 34 can be either liquid, supercritical, or a combination thereof.

The input parameters used to control the solvent wash and carbon dioxide cleaning stages can also be varied. For example, the temperature, pressure and duration of time can be varied at stages 12 and/or 34. If the temperature, pressure and duration of the solvent wash 12 and carbon dioxide cleaning stage 34 are all modified, then the PCB contamination level may be able to be reduced to an acceptable level in few cycles. In other embodiments, more than five cycles may be needed or desired.

Furthermore, the aforementioned sequence of a solvent wash, separation and exposure to carbon dioxide does not necessarily have to be strictly followed and may be altered. The resin particles may undergo any number of successive solvent washes. For example, the number of solvent wash-separation-carbon dioxide cycles can be either less (one through four) or more than five. In various embodiments, the applicant has found that one, two, three, four, five, six or more cycles, where each cycle includes (i) a solvent wash, (ii) separation of the solvent and the resin particles and the solvent, and (iii) exposure to of the resin particles after separation to the carbon dioxide. The applicant has found that with repeated cycles, the PCB levels can be removed down to substantially zero.

Similarly, each cycle may also be altered. For example, each cycle may include one, two three, four or more solvent washes followed by separation and exposure to carbon dioxide. The number and possible variations or combinations of the basic solvent wash, separation, and carbon dioxide exposure steps of the process are too numerous to exhaustively list herein. In general terms, the present invention is intended to cover the basic concept of recovering PCBs from resins using a solvent, followed by separation of the solvent and resin, and then exposure to a solvent removing agent to remove any residual solvent remaining on the resin after the separation. In the order of the sequence, the number of cycles, and in particular the number of solvent washes that may occur before the exposure to the carbon dioxide in each cycle or other solvent removing agent as specifically described herein for the purposes of illustration should in no way be construed as limiting the present invention. Either one or multiple solvent washes can occur before each carbon dioxide exposure, or vice versa, for each cycle. And one or multiple cycles may be used.

In alternative embodiments, sulfur hexafluoride can be used as the solvent removing agent, either alone or in combination with carbon dioxide, and either in a liquid or supercritical state.

Also, it may also not be practical to physically provide multiple solvent wash systems 12 and carbon dioxide systems 34 at a single location. In alternative embodiments, a single solvent wash 12, separator 26, and carbon dioxide system 34 may be used and the resin material may be passed through the single system multiple times, as needed.

Lastly, it is preferable that parallel solvent wash and carbon dioxide cleaning stages are provided for each type of resin stored in the silos 310. However, such an arrangement may not be practical due to cost and space limitations. In which case, the different types of resins stored in the silos 310a-310d can be alternatively passed through the solvent wash and carbon dioxide stages.

As illustrated in FIG. 3C, the substantially PCB-free resin following the last solvent wash and carbon exposure cycle is stored in a silo 320. Typically, a different silo is proved for each of the types of resin sorted in the sink-float separation tanks 309a-309d. The resin stored in the silo 320 is passed through an air classifier 322, which blows air over the resin, removing any remaining dirt or debris. The resin is then passed through a number of optical sorters 314a-314c, which sort by color. Thereafter, the color-sorted resin is passed through a ferrous/non-ferrous metal detector 324 and any metal remaining in the resin is removed. The resin is then stored in a silo 326. In an optional final step, the resin particles are pelletized in stage 318. The pelletizer 318 heats the resin particles from a solid state into a liquid state. The liquid is then pushed or extruded through a filter screen and die plate. The filter screen removes any particles or contaminants in the liquid resin. As the liquid is extruded through the die plate, knife blades cut the resin, forming pellets upon solidification. The pellets can then be used to make new resin based products. For example depending on the type of resin, it could be used to make beverage containers (i.e., bottles), packaging for consumer products, parts for new automobiles, or just about any other application where virgin resin is used.

Although the invention has been described with reference to the embodiments illustrated in the attached drawing figures, it is noted that equivalents may be employed and substitutions made herein without departing from the scope of the invention as recited in the claims. For example, the sorting can occur using some other criteria besides the color or the containers or the type of material. The size in which the resin particles are ground is also optional and can be made either larger or smaller than specified herein. The type of solvent or the solvent removing agent used is also arbitrary and does not necessarily have to be of the same type or phase described herein.

Having thus described the various embodiment of the invention, what is claimed as new and desired to be protected by Letters Patent includes the following:

1. A method for removing PCBs from resin, comprising:
(i) exposing resin particles to a solvent in a solvent wash, the solvent contacting the resin particles to remove PCBs on the resin particles in the solvent wash;
(ii) separating the solvent from the resin particles after removal from the solvent wash;
(iii) exposing the resin particles to a solvent removing agent to substantially remove residual solvent and PCBs on the resin particles; and
repeating (i), (ii) and (iii) until the PCBs on the resin particles are reduced to a predetermined level.

2. The method of claim 1, further comprising repeating (i) and (iii) one of the following number of times:
a. two times;
b. three times;
c. four times;
d. five; or
e. six or more times.

3. The method of claim 1, wherein exposing the resin particles to the solvent further comprises:
heating the solvent to a predetermined temperature; and
agitating the resin particles in the heated solvent.

4. The method of claim 1, wherein the resin particles are exposed to the solvent in the solvent wash for a predetermined period of time consisting of one of the following: less than 15 minutes; between 1 to 12 minutes; approximately 4 minutes, or 6 minutes or less.

5. The method of claim 2, wherein the predetermined temperature consists of one of the following: less than 190 degrees Fahrenheit, a range from 170 to 190 degrees Fahrenheit; a range of 90 to 110 degrees Fahrenheit; or approximately 120 degrees Fahrenheit.

6. The method of claim 1, wherein exposing the resin particles to the solvent further comprises either:
(i) successive solvent washes on the resin particles in a plurality of tanks; or
(ii) performing successive solvent washes on the resin particles in the same tank.

7. The method of claim 1, wherein the solvent is an organic solvent.

8. The method of claim 1 wherein the solvent is selected from the group consisting of amyl propionate, butyl butyrate, alkyl lactates, ethyl hexyl acetate, dibasic esters, methyl soyate, ethyl soyate, cyclohexanone, methyl ethyl ketone, dipropylene glycol, dipropylene glycol methyl ether, trichloroethylene, xylene, ethanol, tetrahydrofurluryl, hexane, mineral spirits, monoethanolamine, d-limonene, dimethyl formamide, n-methyl pyrrolodine, propylene carbonate, and combinations thereof, and
wherein said alkyl lactate is selected from the group consisting of methyl lactate, ethyl lactate, isopropyl lactate, butyl lactate and combinations thereof.

9. The method of claim 1, wherein the solvent is an alkyl ester solvent having the general formula RCOOR′, wherein R and R′ are independently selected from C1-C10 alkyl groups and R contains at least one hydroxyl group.

10. The method of claim 1, wherein the resin particles are selected from the group consisting of polypropylene, polyethylene, polyethylene terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), and combinations thereof.

11. The method of claim 1, further comprising:
periodically removing the solvent contacting the resin particles, the solvent being contaminated with the PCBs;
converting the removed solvent into a gaseous state,
precipitating the PCBs out of the solvent while in the gaseous state;
collecting the precipitated PCBs;
converting the solvent to a non-gaseous state, the solvent being substantially PCB free; and
reusing the substantially contamination free solvent to again contact the resin particles.

12. The method of claim 1, separating the solvent and the resin particles further comprises;
removing the resin particles from the solvent wash; and
spinning the resin particles to further remove the solvent from the resin particles.

13. The method of claim 1, wherein the exposing the resin particles to the solvent removing agent further comprises:
placing the resin particles into a vessel;
introducing the solvent removing agent into the vessel at a first location;
removing the solvent removing agent from the vessel at a second location;
exposing the resin particles in the vessel to the solvent removing agent as the solvent removing agent moves from the first location and the second location; and
removing the resin particles from the vessel after exposure to the solvent removing agent in the vessel.

14. The method of claim 13, wherein the solvent removing agent is a fluid containing.

15. The method of claim 14, further comprising performing one or more of the following:
(i) maintaining the pressure of the fluid containing the carbon dioxide in the vessel in a range of approximately 600 to 1000 pounds per square inch (psi);
(ii) maintaining the temperature of the fluid containing the carbon dioxide in the vessel in a range of approximately 20 to 100 degrees Celsius; and/or
(iii) agitating the resin particles in the vessel while exposed to the fluid containing the carbon dioxide.

16. The method of claim 1, wherein during (iii), the resin particles are exposed to the solvent removing agent for one of the following predetermined periods of time: six minutes or less; ten minutes or less; twelve minutes or less; fifteen minutes or less; twenty minutes or less; or thirty minutes or less.

17. The method of claim 1, further comprising, prior to exposing the resin particles to the solvent, performing one or more of the following:
separating resin from auto shredder residue;
grinding the separated resin into the resin particles; and
separating the resin particles by density.

18. The method of claim 1, after the PCBs have been removed from the resin particles to the predetermined level, optically sorting the resin particles by color.

19. A system for removing PCBs from resin, comprising:
(i) one or more solvent wash tanks to expose resin particles to a solvent wash, the solvent contacting the resin particles to remove PCBs on the resin particles in the solvent wash;
(ii) one or more separators to separate the solvent from the resin particles after removal from the solvent wash; and
(iii) one or more solvent removing vessels to expose the resin particles to a solvent removing agent to substantially remove residual solvent and PCBs on the resin particles,
wherein, the resin particles are exposed to the solvent in the one or more solvent wash tanks one or more times and the solvent removing agent in the one or more carbon dioxide vessels one or more times until the PCBs on the resin particles have been reduced to a predetermined level.

20. The system of claim 19, wherein the solvent is selected from the group consisting of amyl propionate, butyl butyrate, alkyl lactates, ethyl hexyl acetate, dibasic esters, methyl soyate, ethyl soyate, cyclohexanone, methyl ethyl ketone, dipropylene glycol, dipropylene glycol methyl ether, trichloroethylene, xylene, ethanol, tetrahydrofurluryl, hexane, mineral spirits, monoethanolamine, d-limonene, dimethyl formamide, n-methyl pyrrolodine, propylene carbonate, and combinations thereof, and
wherein said alkyl lactate is selected from the group consisting of methyl lactate, ethyl lactate, isopropyl lactate, butyl lactate and combinations thereof.

21. The system of claim 19, wherein the resin particles are selected from the group consisting of polypropylene, polyethylene, polyethylene terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), and combinations thereof.

22. The system of claim 19, further comprising:
a first storage tank for storing solvent contaminated with the PCBs and removed from the solvent wash tank;
a precipitation element to convert the stored solvent into a gaseous state, the PCBs precipitating out of the solvent while in the solvent is in the gaseous state;
a collection element to collect the precipitated PCBs; and
a second storage tank to store the substantially PCB free solvent after the solvent has been converted back to liquid state.

23. The system of claim 19, wherein the one or more separators each further comprising a spinning element to spin the resin particles after removal from the solvent wash tank to further remove the solvent from the resin particles.

24. The system of claim 19, wherein the one or more solvent removing vessels further comprises:
an inlet to introduce the solvent removing agent into the vessel; and
an outlet to remove the solvent removing agent from the vessel,
wherein the resin particles are exposed to the solvent removing agent as the solvent removing agent moves from the inlet to the outlet.

25. The system of claim 19, wherein the predetermined level is one of the following: 1.0 part per million, 2.0 parts per million or less; 3.0 parts per million, 5.0 parts per million, 10.0 parts per million, 50 parts per million.

26. The system of claim 19, wherein the solvent removing agent is a fluid containing carbon dioxide.

27. The system of claim 26, wherein the fluid containing the carbon dioxide is either in a liquid or a supercritical state.
